(19) United States
(12) Patent Application Publication
(10) Pub. No.: US 2025/0333669 A1
(43) Pub. Date: Oct. 30, 2025

(54) SUPERPOSED MULTI-SECTIONED WATER-SOLUBLE UNIT DOSE AUTOMATIC DISHWASHING DETERGENT POUCH

(71) Applicant: The Procter & Gamble Company, Cincinnati, OH (US)

(72) Inventors: Patrick Firmin August DELPLANCKE, Steenhuize-Wijnhuize (BE); Katrien Andrea Lieven VAN ELSEN, Puurs (BE)

(21) Appl. No.: 19/262,185

(22) Filed: Jul. 8, 2025

Related U.S. Application Data
(63) Continuation of application No. PCT/US2024/010792, filed on Jan. 9, 2024.

(30) Foreign Application Priority Data
Jan. 9, 2023 (EP) 23150691.6
Jan. 9, 2023 (EP) 23150693.2
Jan. 9, 2023 (EP) 23150694.0
Jan. 9, 2023 (EP) 23150696.5
Jan. 9, 2023 (EP) 23150697.3

(51) Int. Cl. C11D 17/04

(52) U.S. Cl. CPC C11D 17/045

(57) ABSTRACT

A superposed multi-sectioned water-soluble unit dose automatic dishwashing detergent pouch having specific dimensions and configuration. The pouch includes a first section that is superposed onto a second section. The first section includes one or more internal compartments, and the second section includes one or more internal compartments. The pouch contains an automatic dishwashing detergent composition, and the automatic dishwashing detergent comprises a first component and a second component. The first section of the pouch contains the first component, and the second section of the pouch contains the second component.

### FIELD OF THE INVENTION

The present invention relates to a superposed multi-sectioned water-soluble unit dose automatic dishwashing detergent pouch having specific dimensions and configuration.

### BACKGROUND OF THE INVENTION

A highly desired automatic dishwashing detergent product is a superposed pouch that comprises one section that is superposed onto a second section.

Consumers like the convenience of unit dose product form, and not having to dose free flowing powder or liquid from a container such as a bottle into the dispensing drawer of an automatic dishwasher which can be messy and lead to variation in the amount of detergent dosed, and hence performance of, the wash cycle.

The multi-sectioned aspect of the pouch also means the detergent formulators can more easily combine liquid and solid ingredients together in one product form. For example, having one internal compartment that comprises a solid portion, and a second (and different) internal compartment that comprises a liquid portion. This means the detergent formulator can incorporate a wider range of chemistry into the detergent product, which in turn enables increased performance, often in multiple benefit spaces, such as improved cleaning performance, as well as improved anti-spotting, drying, care and glean performance.

The superposed configuration of the pouch is also a desired aspect of the detergent product. The superposed pouch tends to be more rigid and stable than other pouch forms, such as side-by-side pouch configurations, and tend to be more ergonomically preferred, and easier to handle and use.

One disadvantage of these superposed unit dose pouches is the amount of chemistry that can be introduced into the product whilst still allowing the pouch to be easily used by the dispenser drawer. If more chemistry is to be incorporated into the pouch, the size of the pouch and its dimensions need to be carefully controlled to enable good performance and ease of use. As well as ease of use, the size and dimensions of the superposed sections also needs to be carefully controlled to allow for improved performance. Release from the dispenser drawer, rate of dissolution into the wash water are all impacted by the size and dimensions of the sections of the pouch.

Increasing the size of the pouch, and the increase in available volume for the detergent composition also allows for improved formulation strategies, such as improving the cleaning performance, shine performance, anti-spotting performance, care performance, environmental performance of the detergent product, and having an economical cost and efficiency of manufacture. The choice of size and dimension of each section of the superposed pouch impacts the formulation strategy to achieve these improved performances.

### SUMMARY OF THE INVENTION

The present invention, in an example, provides a superposed multi-sectioned water-soluble unit dose automatic dishwashing detergent pouch, wherein the pouch comprises a first section that is superposed onto a second section, wherein the first section comprises one or more internal compartments, wherein the second section comprises one or more internal compartments, wherein the pouch comprises an automatic dishwashing detergent composition, wherein the automatic dishwashing detergent comprises a first component and a second component, wherein the first section of the pouch comprises the first component of the detergent composition, wherein the second section of the pouch comprises the second component of the detergent composition, wherein the pouch has an ellipsoid shape having the following dimensions:
(i) a major axis in the range of from 42 mm to 90 mm;
(ii) a minor axis in the range of from 30 mm to 54 mm;
(iii) a height in the range of from 14 mm to 41 mm; and
(iv) a total internal compartment volume in the range of from 18 ml to 199 ml,
wherein the first section has the following dimensions:
(i) a major axis in the range of from 42 mm to 90 mm;
(ii) a minor axis in the range of from 30 mm to 54 mm;
(iii) a height in the range of from 10 mm to 39 mm; and
(iv) a total internal compartment volume of from 12.6 ml to 189.54 ml,
wherein the second section has the following dimensions:
(i) a height in the range of from 2.0 mm to 31 mm; and
(ii) a total internal compartment volume of at least 3.0 ml.

### DETAILED DESCRIPTION OF THE INVENTION

### Pouch and Detergent Composition

The superposed multi-sectioned water-soluble unit dose automatic dishwashing detergent pouch comprises a first section that is superposed onto a second section. The first section comprises one or more internal compartments. The second section comprises one or more internal compartments. The pouch comprises an automatic dishwashing detergent composition. The automatic dishwashing detergent comprises a first component and a second component. The first section of the pouch comprises the first component of the detergent composition. The second section of the pouch comprises the second component of the detergent composition.

The pouch has an ellipsoid shape having the following dimensions:
(i) a major axis in the range of from 42 mm to 90 mm, or from 45 mm to 80 mm, or from 45 mm to 70 mm, or from 45 mm to 55 mm;
(ii) a minor axis in the range of from 30 mm to 54 mm, or from 32 mm to 40 mm; (iii) a height in the range of from 14 mm to 41 mm, or from 14 mm to 25 mm, or from 14 mm to 20 mm; and
(iv) a total internal compartment volume in the range of from 18 ml to 199 ml, or from 20 ml to 150 ml, or from 20 ml to 50 ml.

Typically, the first section also has an ellipsoid shape. The first section has the following dimensions:
(i) a major axis in the range of from 42 mm to 90 mm, or from 45 mm to 80 mm, or from 45 mm to 70 mm, or from 45 mm to 55 mm;
(ii) a minor axis in the range of from 30 mm to 54 mm, or from 32 mm to 40 mm;
(iii) a height of from 10 mm to 39 mm; or from 14 mm to 23 mm, or from 10 mm to 18 mm; and
(iv) a total internal compartment volume of from 12.6 ml to 189.54 ml, or from 15 ml to 150 ml, or from 15 ml to 47 ml.

The second section has the following dimensions:
(i) a height in the range of from 2.0 mm to 31 mm; and
(ii) a total internal compartment volume in the range of at least 3.0 ml, or at least 3.5 ml, or at least 4.0 ml.

The pouch has an ellipsoid shape. Ellipsoid shape includes ellipsoid-like shapes, such as distorted ellipsoid shapes. The second section, being superposed onto the first section, can result in the pouch having a distorted ellipsoid shape.

The major axis of the pouch can be considered as the maximum length, or the length, of the pouch. The minor axis of the pouch can be considered as the maximum width, or the width, of the pouch.

The major axis of the first section can be considered as the maximum length, or the length, of the first section. The minor axis of the first section can be considered as the maximum width, or the width, of the first section.

Preferably, the first section comprises only one internal compartment. However, it is possible for the first section to comprise more than one internal compartment, such as two or more, or three or more, or four or more, or five or more, or six or more, or seven or more, or eight or more, or nine or more, or even ten or more internal compartments. These internal compartments of the first section may each independently comprise a portion of the first component of the detergent composition.

The second section may comprise only internal compartment. However, it may be preferred for the second section to comprise more than one internal compartment, such as two or more, or three or more, or four or more, or five or more, or six or more, or seven or more, or eight or more, or nine or more, or even ten or more internal compartments. These internal compartments of the second section may each independently comprise a portion of the second component of the detergent composition. Preferably, the second section comprises from three to six internal compartments, preferably from four to six internal compartments.

The first component of the detergent composition is preferably in the form of a powder. However, it is possible for the first component to be in other forms such as a liquid, or even a combination of forms, such as having a portion of the first component in powder form and a portion in liquid form. It may be possible for one portion to be a powder that is dispersed within a liquid portion, or for a liquid portion, such as a gel, to be present next to a powder portion.

The second component of the detergent composition is preferably in the form of a liquid. A suitable liquid includes a gel. It is also possible for the second component to be in other forms such as a powder, or even a combination of forms, such as having a portion of the second component in powder form and a portion in liquid form. It may be possible for one portion to be a powder that is dispersed within a liquid portion, or for a liquid portion, such as a gel, to be present next to a powder portion. When the second section comprises more than one internal compartment, it may also be possible for these internal compartments to comprise portions that are in different forms, such as one internal compartment comprising a solid portion and another internal compartment comprising a liquid portion. However, even when the second section comprises more than one internal compartment, preferably each of these internal compartments all comprise a portion that is in liquid form.

The first component may be in solid particulate form. The second component may be in liquid form. The weight ratio of first component to second component may be in the range of from 2.0:1 to 5.0:1.

The first component of the detergent composition may be in solid particulate form and has a bulk density of less than 1000 g/1, or less than 800 g/l, or less than 600 g/l, or less than 500 g/1, or even less than 400 g/l.

### Surfactant

The automatic dishwashing detergent composition may comprise from 2400 mg to 9000 mg, preferably from 2500 mg to 7500 mg, or from 2600 mg to 6000 mg, or from 2700 mg to 5000 mg, or from 2800 mg to 4000 mg surfactant.

Preferably, the surfactant is selected from:
(i) R—O-EOₓ, wherein R is a C₆-C₁₈ alkyl, and x is from 1 to 30; or
(ii) R—O-EOₓPO_{y}, wherein R is a C₆-C₁₈ alkyl, x is from 1 to 20, and y is from 1 to 20; or
(iii) R—O—PO_{y}EOₓ, wherein R is a C₆-C₁₈ alkyl, x is from 1 to 20, and y is from 1 to 20; or (iv) R—O-EOₓPO_{y}EOₓ, wherein R is a C₆-C₁₈ alkyl, each x is independently from 1 to 20, and y is from 1 to 20; or
(v) R—O—PO_{y}EOₓPO_{y}, wherein R is a C₆-C₁₈ alkyl, x is from 1 to 20, and each y is independently from 1 to 20; or
(vi) HO-EOₓPO_{y}EOₓ—H, wherein, each x is independently from 1 to 50, and y is from 1 to 20; or
(vii) HO—PO_{y}EOₓPO_{y}—H, wherein x is from 1 to 50, and each y is independently from 1 to 50; or
(viii) any combination thereof.

Preferably, the second component of the automatic dishwashing detergent composition comprises from 900 mg to 2000 mg surfactant having the formula:

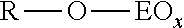

wherein:
R is a C₆-C₁₈ alkyl; and
x is from 1 to 30.

This is especially preferred when the second component is in liquid form.

Preferably, the second component of the automatic dishwashing detergent composition comprises from 300 mg to 1000 mg surfactant having the formula:

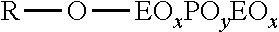

wherein:
R is a C₆-C₁₈ alkyl;
each x is independently from 1 to 20; and
y is from 1 to 20.

This is especially preferred when the second component is in liquid form.

Preferably, the second component of the automatic dishwashing detergent composition comprises from 300 mg to 1000 mg surfactant having the formula:

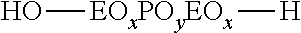

wherein:
R is a C₆-C₁₈ alkyl;
each x is independently from 1 to 20; and
y is from 1 to 20.

This is especially preferred when the second component is in liquid form.

Preferably, the second component of the automatic dishwashing detergent composition comprises from:
(i) 900 mg to 2000 mg surfactant having the formula:

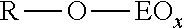

wherein:
R is a C₆-C₁₈ alkyl; and
x is from 1 to 30; and
(ii) from 300 mg to 1000 mg surfactant having the formula:

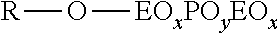

wherein:
R is a C₆-C₁₈ alkyl;
each x is independently from 1 to 20; and
y is from 1 to 20; and
(iii) from 300 mg to 1000 mg surfactant having the formula:

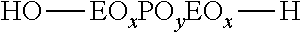

wherein:
each x is independently from 1 to 50; and
y is from 1 to 20.

This is especially preferred when the second component is in liquid form.

Preferably, the automatic dishwashing detergent composition comprises polymer. Preferably, the automatic dishwashing detergent composition comprises polymer in an amount such that the weight ratio of surfactant to polymer present in the composition is in the range of from 8:1 to 50:1, or from 8:1 to 40:1, or from 8:1 to 30:1, or from 8:1 to 20:1, or from 8:1 to 15:1, or from 8:1 to 12:1.

Preferably, the automatic dishwashing detergent composition comprises carboxylate polymer. Preferably, the automatic dishwashing detergent composition comprises carboxylate polymer in an amount such that the weight ratio of surfactant to carboxylate polymer present in the composition is in the range of from 8:1 to 50:1, or from 8:1 to 40:1, or from 8:1 to 30:1, or from 8:1 to 20:1, or from 8:1 to 15:1, or from 8:1 to 12:1. The carboxylate polymer, or a portion thereof, may be modified, such as sulphonated.

It may be preferred for the automatic dishwashing detergent composition to comprise a sulphonated carboxylate polymer. Preferably, the automatic dishwashing detergent composition comprises sulphonated carboxylate polymer in an amount such that the weight ratio of surfactant to carboxylate polymer present in the composition is in the range of from 8:1 to 50:1, or from 8:1 to 40:1, or from 8:1 to 30:1, or from 8:1 to 20:1, or from 8:1 to 15:1, or from 8:1 to 12:1.

Preferably, the automatic dishwashing detergent composition comprises percarbonate bleach. Preferably, the automatic dishwashing detergent composition comprises percarbonate bleach in an amount such that the weight ratio of surfactant to percarbonate bleach present in the composition is in the range of from 7:1 to 50:1, or from 7:1 to 40:1, or from 7:1 to 30:1 or from 7:1 to 20:1. A preferred percarbonate bleach is sodium percarbonate, such as coated sodium percarbonate. The percarbonate bleach is preferably present in the first component of the automatic dishwashing detergent composition.

The second section of the pouch may comprise at least three internal compartments. Each of these three internal components may comprise a portion of the second component. Each of these three internal components may comprise:
(i) a surfactant having the structure R—O-EOₓ, wherein R is a C₆-C₁₈ alkyl, and x is from 1 to 30; and
(ii) a surfactant having the structure HO-EOₓPO_{y}EOₓ—H, wherein, each x is independently from 1 to 50, and y is from 1 to 20.

The second section may also comprise a fourth internal compartment. This fourth internal compartment of the second section may comprise a portion of the second component. This fourth internal compartment may comprise:
(i) a surfactant having the structure R—O-EOₓ, wherein R is a C₆-C₁₈ alkyl, and x is from 1 to 30;
(ii) a surfactant having the structure HO-EOₓPO_{y}EOₓ—H, wherein, each x is independently from 1 to 50, and y is from 1 to 20; and
(iii) a surfactant having the structure R—O—PO_{y}EOₓPO_{y}, wherein R is a C₆-C₁₈ alkyl, x is from 1 to 20, and each y is independently from 1 to 20.

The second section may comprise a fifth internal compartment. This fifth internal compartment of the second section may comprises a portion of the second component. This fifth internal compartment may comprise:
(i) a surfactant having the structure R—O-EOₓ, wherein R is a C₆-C₁₈ alkyl, and x is from 1 to 30;
(ii) a surfactant having the structure HO-EOₓPO_{y}EOₓ—H, wherein, each x is independently from 1 to 50, and y is from 1 to 20; and
(iii) a surfactant having the structure R—O—PO_{y}EOₓPO_{y}, wherein R is a C₆-C₁₈ alkyl, x is from 1 to 20, and each y is independently from 1 to 20.

### Enzyme

The automatic dishwashing detergent composition may comprise, on an active enzyme basis, from 0.5 mg to 20 mg, or from 3.0 mg to 19 mg, or from 5.0 mg to 18 mg, or from 6.0 mg to 15 mg, or from 7.0 mg to 14 mg, or from 8.0 mg to 12 mg, or from 0.5 mg to 5.0 mg, or from 0.6 mg to 4.0 mg, or from 0.7 mg to 3.0 mg, or from 0.8 mg to 2.0 mg, or from 0.9 mg to 1.5 mg amylase. Suitable amylases are described in more detail below.

The automatic dishwashing detergent composition may comprise, on an active enzyme basis, from 10 mg to 150 mg, or from 20 mg to 140 mg, or from 40 mg to 130 mg, or from 50 mg to 120 mg, or from 60 mg to 110 mg, or from 70 mg to 100 mg, from 10 mg to 50 mg, or from 10.5 mg to 40 mg, or from 11 mg to 30 mg, or from 11.5 mg to 20 mg, or from 12 mg to 15 mg protease. Suitable proteases are described in more detail below.

The automatic dishwashing detergent composition may comprise at least one, or at least two, or at least three, or at least four, or even at least five additional enzymes selected from lipase, phospholipase, bleaching enzyme, cellulase, glucanase, hemicellulose, mannanase, xylanase, and/or glycosyl hydrolase.

The first component of the detergent composition may be in solid form and comprise the protease and/or amylase.

### Complexing Agent System

Complexing agents are materials capable of sequestering hardness ions, particularly calcium and/or magnesium.

The automatic dishwashing detergent composition may comprise:
(i) from 500 mg to 3000 mg, or from 500 mg to 2500 mg, or from 500 mg to 2000 mg, or from 500 mg to 1500 mg, or from 500 mg to 1000 mg methylglycine-N,N-diacetic acid and/or a salt thereof; and
(ii) from greater than 2000 mg to 12000 mg, or from 3000 mg to 8000 mg, or from 4000 mg to 6000 mg, citric acid and/or a salt thereof.

Preferably, the weight ratio of methylglycine-N,N-diacetic acid and/or a salt thereof to citric acid and/or a salt thereof is in the range of from 0.08 to 0.90:1, or from 0.09:1 to 0.85:1, or from 0.10:1 to 0.80:1.

The first component of the automatic dishwashing detergent composition is preferably in solid form and comprises:
(i) from 500 mg to 3000 mg, or from 500 mg to 2500 mg, or from 500 mg to 2000 mg, or from 500 mg to 1500 mg, or from 500 mg to 1000 mg, methylglycine-N,N-diacetic acid and/or a salt thereof; and
(ii) from greater than 2000 mg to 12000 mg, or from 3000 mg to 8000 mg, or from 4000 mg to 6000 mg, citric acid and/or a salt thereof.

The first component may comprises from 500 mg to 3000 mg, or from 500 mg to 2500 mg, or from 500 mg to 2000 mg, or from 500 mg to 1500 mg, or from 500 mg to 1000 mg, methylglycine-N,N-diacetic acid and/or a salt thereof. This is preferred when the first component is in solid form.

The first component may comprise from greater than 2000 mg to 12000 mg, or from 3000 mg to 8000 mg, or from 4000 mg to 6000 mg citric acid and/or a salt thereof. This is preferred when the first component is in solid form.

The methylglycine-N,N-diacetic acid and/or a salt thereof is preferably the tri-sodium salt of methylglycine-N,N-diacetic acid.

The citric acid and/or a salt thereof is preferably sodium citrate.

Other suitable complexing agents that may also be present include glutamic acid-N,N-diacetic acid (GLDA), iminodisuccinic acid (IDS), aspartic acid —N,N-diacetic acid (ASDA) its salts and mixtures thereof.

The composition may also comprise from 750 mg to 2000 mg 1-hydroxyethylidene 1,1-diphosphonic acid.

### Other Ingredients

The automatic dishwashing detergent composition may be free of benzotriazole and tolyltriazole.

The automatic dishwashing detergent composition may comprise from 3000 mg to 10000 mg, or from 3000 mg to 8000 mg, or from 3000 mg to 6000 mg, percarbonate bleach. A preferred percarbonate bleach is sodium percarbonate, such as a coated sodium percarbonate.

It may be preferred for the automatic dishwashing detergent composition comprises less than 3000 mg, or less than 2000 mg, or less than 1500 mg, or less than 1000 mg, or even less than 500 mg percarbonate bleach. It may even be preferred for the composition to be free of percarbonate bleach.

The composition may comprise from 2000 mg to 12000 mg filler material.

### Further Detergent Composition Description

The composition is preferably enveloped by a water-soluble film such as polyvinyl alcohol. Especially preferred are compositions in unit dose form wrapped in a polyvinyl alcohol film having a thickness of less than 100 μm.

The composition is preferably phosphate free.

The detergent composition may comprise a terpolymer. Suitable terpolymers comprise monomers of a vinyl lactam, monomers of (meth)acrylic acid and monomers of a linear or branched C1-C20 alkyl (meth)acrylate. Preferably, the terpolymer comprises monomers of vinylpyrrolidone, monomers of acrylic acid and monomers of a linear or branched C1-C20 alkyl (meth)acrylate. Preferably, the terpolymer comprises: i) from about 20% to about 90%, preferably from about 40 to about 70% by weight of vinylpyrrolidone, ii) from about 1 to about 55%, preferably from about 15 to 40% by weight of (meth)acrylic acid; and iii) from about 1 to about 25%, preferably from about 5 to about 20% by weight of a linear or branched C1-C20 alkyl (meth)acrylate. Preferably, the terpolymer has a weight average molecular weight of from about 10000 gmol-1 to about 2000000 gmol-1 as measured via appropriate techniques. A preferred linear or branched C1-C20 alkyl (meth)acrylate is lauryl methacrylate. Terpolymers suitable for use herein include Styleze 2000 and Acrylidone LM, both provided by Ashland. Preferably, the composition of the invention comprises from about 0.1% to about 10%, preferably from about 0.2% to about 5% by weight of the composition of terpolymer.

Surfactants suitable for use herein include non-ionic surfactants, preferably the compositions are free of any other surfactants. Traditionally, non-ionic surfactants have been used in automatic dishwashing for surface modification purposes in particular for sheeting to avoid filming and spotting and to improve shine. It has been found that non-ionic surfactants can also contribute to prevent redeposition of soils.

Preferably the composition comprises a non-ionic surfactant, preferably a non-ionic surfactant system, more preferably the non-ionic surfactant or a non-ionic surfactant system has a phase inversion temperature, as measured at a concentration of 1% in distilled water, between 2° and 70° C., preferably between 35 and 65° C. By a “non-ionic surfactant system” is meant herein a mixture of two or more non-ionic surfactants. Preferred for use herein are non-ionic surfactant systems. They seem to have improved cleaning and finishing properties and better stability in product than single non-ionic surfactants.

Phase inversion temperature is the temperature below which a surfactant, or a mixture thereof, partitions preferentially into the water phase as oil-swollen micelles and above which it partitions preferentially into the oil phase as water swollen inverted micelles. Phase inversion temperature can be determined visually by identifying at which temperature cloudiness occurs.

The phase inversion temperature of a non-ionic surfactant or system can be determined as follows: a solution containing 1% of the corresponding surfactant or mixture by weight of the solution in distilled water is prepared. The solution is stirred gently before phase inversion temperature analysis to ensure that the process occurs in chemical equilibrium. The phase inversion temperature is taken in a thermostable bath by immersing the solutions in 75 mm sealed glass test tube. To ensure the absence of leakage, the test tube is weighed before and after phase inversion temperature measurement. The temperature is gradually increased at a rate of less than 1° C. per minute, until the temperature reaches a few degrees below the pre-estimated phase inversion temperature. Phase inversion temperature is determined visually at the first sign of turbidity.

Suitable nonionic surfactants include: i) ethoxylated non-ionic surfactants prepared by the reaction of a monohydroxy alkanol or alkyphenol with 6 to 20 carbon atoms with preferably at least 3 moles particularly preferred at least 5 moles, and still more preferred at least 7 moles of ethylene oxide per mole of alcohol or alkylphenol; ii) alcohol alkoxylated surfactants having from 6 to 20 carbon atoms and at least one ethoxy and propoxy group. Preferred for use herein are mixtures of surfactants i) and ii).

Other suitable non-ionic surfactants are epoxy-capped poly(oxyalkylated) alcohols represented by the formula:

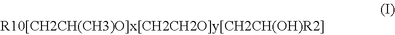

wherein R1 is a linear or branched, aliphatic hydrocarbon radical having from 4 to 18 carbon atoms; R2 is a linear or branched aliphatic hydrocarbon radical having from 2 to 26 carbon atoms; x is an integer having an average value of from 0.5 to 1.5, more preferably about 1; and y is an integer having a value of at least 15, more preferably at least 20.

Preferably, the surfactant of formula I, has at least about 10 carbon atoms in the terminal epoxide unit [CH2CH(OH)R2]. Suitable surfactants of formula I, according to the present invention, are Olin Corporation's POLY-TERGENT® SLF-18B nonionic surfactants, as described, for example, in WO 94/22800, published Oct. 13, 1994 by Olin Corporation.

Preferably, the non-ionic surfactant is a surfactant system comprising at least two non-ionic surfactants. Preferably at least one of the non-ionic surfactants of the surfactant system is an ethoxylated alcohol which comprises from 5 to 25 moles of ethylene oxide per mole of surfactant, more preferably the surfactant system also comprises an alkoxylated alcohol comprising ethoxy and propoxy groups. Preferably, the weight ratio of the two non-ionic surfactants, i.e., ethoxylated alcohol to alkoxylated alcohol comprising ethoxy and propoxy groups is from 2:1 to 1:2.

Excellent drying and shine benefits are obtained with compositions comprising a dispersant polymer and/or a complexing agent. For the purpose of this invention a “complexing agent” is a compound capable of binding polyvalent ions such as calcium, magnesium, lead, copper, zinc, cadmium, mercury, manganese, iron, aluminium and other cationic polyvalent ions to form a water-soluble complex.

Sulfonated/carboxylated polymers are particularly suitable for the composition of the invention.

Suitable sulfonated/carboxylated polymers described herein may have a weight average molecular weight of less than or equal to about 100,000 Da, or less than or equal to about 75,000 Da, or less than or equal to about 50,000 Da, or from about 3,000 Da to about 50,000, preferably from about 5,000 Da to about 45,000 Da.

Preferred sulfonated monomers include one or more of the following: 1-acrylamido-1-propanesulfonic acid, 2-acrylamido-2-propanesulfonic acid, 2-acrylamido-2-methyl-1-propanesulfonic acid, 2-methacrylamido-2-methyl-1-propanesulfonic acid, 3-methacrylamido-2-hydroxy-propanesulfonic acid, allylsulfonic acid, methallylsulfonic acid, allyloxybenzenesulfonic acid, methallyloxybenzenesulfonic acid, 2-hydroxy-3-(2-propenyloxy) propanesulfonic acid, 2-methyl-2-propen-1-sulfonic acid, styrenesulfonic acid, vinylsulfonic acid, 3-sulfopropyl, 3-sulfo-propylmethacrylate, sulfomethacrylamide, sulfomethylmethacrylamide and mixtures of said acids or their water-soluble salts.

Preferably, the polymer comprises the following levels of monomers: from about 40 to about 90%, preferably from about 60 to about 90% by weight of the polymer of one or more carboxylic acid monomer; from about 5 to about 50%, preferably from about 10 to about 40% by weight of the polymer of one or more sulfonic acid monomer; and optionally from about 1% to about 30%, preferably from about 2 to about 20% by weight of the polymer of one or more non-ionic monomer. An especially preferred polymer comprises about 70% to about 80% by weight of the polymer of at least one carboxylic acid monomer and from about 20% to about 30% by weight of the polymer of at least one sulfonic acid monomer.

In the polymers, all or some of the carboxylic or sulfonic acid groups can be present in neutralized form, i.e., the acidic hydrogen atom of the carboxylic and/or sulfonic acid group in some or all acid groups can be replaced with metal ions, preferably alkali metal ions and in particular with sodium ions.

The carboxylic acid is preferably (meth)acrylic acid. The sulfonic acid monomer is preferably 2-acrylamido-2-propanesulfonic acid (AMPS).

Preferred commercially available polymers include: Alcosperse 240 and Aquatreat AR 540 supplied by Nouryon; Acumer 3100, Acumer 2000, Acusol 587G and Acusol 588G supplied by Dow. Particularly preferred polymers are Acusol 587G and Acusol 588G supplied by Dow. Suitable polymers include anionic carboxylic polymer of low molecular weight. They can be homopolymers or copolymers with a weight average molecular weight of less than or equal to about 200,000 g/mol, or less than or equal to about 75,000 g/mol, or less than or equal to about 50,000 g/mol, or from about 3,000 to about 50,000 g/mol, preferably from about 5,000 to about 45,000 g/mol. The dispersant polymer may be a low molecular weight homopolymer of polyacrylate, with an average molecular weight of from 1,000 to 20,000, particularly from 2,000 to 10,000, and particularly preferably from 3,000 to 5,000.

The polymer may be a copolymer of acrylic with methacrylic acid, acrylic and/or methacrylic with maleic acid, and acrylic and/or methacrylic with fumaric acid, with a molecular weight of less than 70,000. Their molecular weight ranges from 2,000 to 80,000 and more preferably from 20,000 to 50,000 and in particular from 30,000 to 40,000 g/mol. and a ratio of (meth)acrylate to maleate or fumarate segments of from 30:1 to 1:2.

The polymer may be a copolymer of acrylamide and acrylate having a molecular weight of from 3,000 to 100,000, alternatively from 4,000 to 20,000, and an acrylamide content of less than 50%, alternatively less than 20%, by weight of the dispersant polymer can also be used. Alternatively, such polymer may have a molecular weight of from 4,000 to 20,000 and an acrylamide content of from 0% to 15%, by weight of the polymer.

Polymers suitable herein also include itaconic acid homopolymers and copolymers.

Alternatively, the polymer can be selected from the group consisting of alkoxylated polyalkyleneimines, alkoxylated polycarboxylates, polyethylene glycols, styrene co-polymers, cellulose sulfate esters, carboxylated polysaccharides, amphiphilic graft copolymers and mixtures thereof.

Inorganic and organic bleaches are suitable for use herein. Inorganic bleaches include perhydrate salts such as perborate, percarbonate, perphosphate, persulfate and persilicate salts. The inorganic perhydrate salts are normally the alkali metal salts. The inorganic perhydrate salt may be included as the crystalline solid without additional protection. Alternatively, the salt can be coated. Suitable coatings include sodium sulphate, sodium carbonate, sodium silicate and mixtures thereof. Said coatings can be applied as a mixture applied to the surface or sequentially in layers.

Alkali metal percarbonates, particularly sodium percarbonate is the preferred bleach for use herein. The percarbonate is most preferably incorporated into the products in a coated form which provides in-product stability.

Potassium peroxymonopersulfate is another inorganic perhydrate salt of utility herein.

Typical organic bleaches are organic peroxyacids, especially dodecanediperoxoic acid, tetradecanediperoxoic acid, and hexadecanediperoxoic acid. Mono- and diperazelaic acid, mono- and diperbrassylic acid are also suitable herein. Diacyl and Tetraacylperoxides, for instance dibenzoyl peroxide and dilauroyl peroxide, are other organic peroxides that can be used in the context of this invention.

Further typical organic bleaches include the peroxyacids, particular examples being the alkylperoxy acids and the arylperoxy acids. Preferred representatives are (a) peroxybenzoic acid and its ring-substituted derivatives, such as alkylperoxybenzoic acids, but also peroxy-α-naphthoic acid and magnesium monoperphthalate, (b) the aliphatic or substituted aliphatic peroxy acids, such as peroxylauric acid, peroxystearic acid, ε-phthalimidoperoxycaproic acid[phthaloiminoperoxyhexanoic acid (PAP)], o-carboxybenzamidoperoxycaproic acid, N-nonenylamidoperadipic acid and N-nonenylamidopersuccinates, and (c) aliphatic and araliphatic peroxydicarboxylic acids, such as 1,12-diperoxycarboxylic acid, 1,9-diperoxyazelaic acid, diperoxysebacic acid, diperoxybrassylic acid, the diperoxyphthalic acids, 2-decyldiperoxybutane-1,4-dioic acid, N,N-terephthaloyldi(6-aminopercaproic acid).

Bleach activators are typically organic peracid precursors that enhance the bleaching action in the course of cleaning at temperatures of 60° C. and below. Bleach activators suitable for use herein include compounds which, under perhydrolysis conditions, give aliphatic peroxoycarboxylic acids having preferably from 1 to 12 carbon atoms, in particular from 2 to 10 carbon atoms, and/or optionally substituted perbenzoic acid. Suitable substances bear O-acyl and/or N-acyl groups of the number of carbon atoms specified and/or optionally substituted benzoyl groups. Preference is given to polyacylated alkylenediamines, in particular tetraacetylethylenediamine (TAED), acylated triazine derivatives, in particular 1,5-diacetyl-2,4-dioxohexahydro-1,3,5-triazine (DADHT), acylated glycolurils, in particular tetraacetylglycoluril (TAGU), N-acylimides, in particular N-nonanoylsuccinimide (NOSI), acylated phenolsulfonates, in particular n-nonanoyl- or isononanoyloxybenzenesulfonate (n- or iso-NOBS), decanoyloxybenzoic acid (DOBA), carboxylic anhydrides, in particular phthalic anhydride, acylated polyhydric alcohols, in particular triacetin, ethylene glycol diacetate and 2,5-diacetoxy-2,5-dihydrofuran and also triethylacetyl citrate (TEAC).

The composition herein preferably contains a bleach catalyst, preferably a metal containing bleach catalyst. More preferably the metal containing bleach catalyst is a transition metal containing bleach catalyst, especially a manganese or cobalt-containing bleach catalyst.

Bleach catalysts preferred for use herein include manganese triazacyclononane and related complexes; Co, Cu, Mn and Fe bispyridylamine and related complexes; and pentamine acetate cobalt(III) and related complexes.

The composition preferably comprises an inorganic builder. Suitable inorganic builders are selected from the group consisting of carbonate, silicate and mixtures thereof. Especially preferred for use herein is sodium carbonate.

In describing enzyme variants herein, the following nomenclature is used for ease of reference: Original amino acid(s):position(s):substituted amino acid(s). Standard enzyme IUPAC 1-letter codes for amino acids are used.

Suitable proteases include metalloproteases and serine proteases, including neutral or alkaline microbial serine proteases, such as subtilisins (EC 3.4.21.62) as well as chemically or genetically modified mutants thereof. Suitable proteases include subtilisins (EC 3.4.21.62), including those derived from Bacillus, such as Bacillus lentus, B. alkalophilus, B. subtilis, B. amyloliquefaciens, Bacillus pumilus and Bacillus gibsonii.

Especially preferred proteases for the detergent of the invention are polypeptides demonstrating at least 90%, preferably at least 95%, more preferably at least 98%, even more preferably at least 99% and especially 100% identity with the wild-type enzyme from Bacillus lentus, comprising mutations in one or more, preferably two or more and more preferably three or more of the following positions, using the BPN′ numbering system and amino acid abbreviations as illustrated in WO00/37627, which is incorporated herein by reference:V68A, N87S, S99D, S99SD, S99A, S101G, S101M, S103A, V104N/I, G118V, G118R, S128L, P129Q, S130A, Y167A, R170S, A194P, V205I and/or M222S.

Most preferably the protease is selected from the group comprising the below mutations (BPN′ numbering system) versus either the PB92 wild-type (SEQ ID NO:2 in WO 08/010925) or the subtilisin 309 wild-type (sequence as per PB92 backbone, except comprising a natural variation of N87S).

$$\begin{matrix}( i ) & G 118 V + S 128 L + P 129 Q + S 130 A \\ ( ii ) & S 101 M + G 118 V + S 128 L + P 129 Q + S 130 A \\ ( iii ) & N 76 D + N 87 R + G 118 R + S 128 L + P 129 Q + S 130 A + S 188 D + N 248 R \\ ( iv ) & N 76 D + N 87 R + G 118 R + S 128 L + P 129 Q + S 130 A + S 188 D + V 244 R \\ ( v ) & N 76 D + N 87 R + G 118 R + S 128 L + P 129 Q + S 130 A \\ ( vi ) & V 68 A + N 87 S + S 101 G + V 104 N\end{matrix}$$

Suitable commercially available protease enzymes include those sold under the trade names Savinase®, Polarzyme®, Kannase®, Ovozyme®, Everlase® and Esperase® by Novozymes A/S (Denmark), those sold under the tradename Properase®, Purafect®, Purafect Prime®, Purafect Ox®, FN3®, FN4®, Excellase®, Ultimase® and Purafect OXP® by Genencor International, those sold under the tradename Opticlean® and Optimase® by Solvay Enzymes, those available from Henkel/Kemira, namely BLAP.

Preferred enzyme for use herein includes alpha-amylases, including those of bacterial or fungal origin. Chemically or genetically modified mutants (variants) are included. A preferred alkaline alpha-amylase is derived from a strain of Bacillus, such as Bacillus licheniformis, Bacillus amyloliquefaciens, Bacillus stearothermophilus, Bacillus subtilis, or other Bacillus sp., such as Bacillus sp. NCIB 12289, NCIB 12512, NCIB 12513, DSM 9375 (U.S. Pat. No. 7,153,818) DSM 12368, DSMZ no. 12649, KSM AP1378 (WO 97/00324), KSM K36 or KSM K38 (EP 1,022,334).

Preferred amylases include:
(a) the variants described in U.S. Pat. No. 5,856,164 and WO99/23211, WO 96/23873, WO00/60060 and WO 06/002643, especially the variants with one or more substitutions in the following positions versus the AA560 enzyme listed as SEQ ID No. 12 in WO 06/002643: 9, 26, 30, 33, 82, 37, 106, 118, 128, 133, 149, 150, 160, 178, 182, 186, 193, 195, 202, 214, 231, 256, 257, 258, 269, 270, 272, 283, 295, 296, 298, 299, 303, 304, 305, 311, 314, 315, 318, 319, 320, 323, 339, 345, 361, 378, 383, 419, 421, 437, 441, 444, 445, 446, 447, 450, 458, 461, 471, 482, 484, preferably that also contain the deletions of D183* and G184*.
(b) variants exhibiting at least 95% identity with the wild-type enzyme from Bacillus sp.707 (SEQ ID NO:7 in U.S. Pat. No. 6,093,562), especially those comprising one or more of the following mutations M202, M208, S255, R172, and/or M261. Preferably said amylase comprises one of M202L or M202T mutations.

Suitable commercially available alpha-amylases include DURAMYL®, LIQUEZYME®, TERMAMYL®, TERMAMYL ULTRA®, NATALASE®, SUPRAMYL®, STAINZYME®, STAINZYME PLUS®, POWERASE®, FUNGAMYL® and BAN® (Novozymes A/S, Bagsvaerd, Denmark), KEMZYM® AT 9000 Biozym Biotech Trading GmbH Wehlistrasse 27b A-1200 Wien Austria, RAPIDASE®, PURASTAR®, ENZYSIZE®, OPTISIZE HT PLUS® and PURASTAR OXAM® (Genencor International Inc., Palo Alto, California) and KAM® (Kao, 14-10 Nihonbashi Kayabacho, 1-chome, Chuo-ku Tokyo 103-8210, Japan). Amylases especially preferred for use herein include NATALASE®, STAINZYME®, STAINZYME PLUS®, POWERASE® and mixtures thereof.

Preferably, the protease and/or amylase of the composition are in the form of granulates, the granulates comprise less than 29% of sodium sulfate by weight of the granulate or the sodium sulfate and the active enzyme (protease and/or amylase) are in a weight ratio of less than 4:1.

The composition preferably comprises an alkoxylated polyalkyleneimine, more preferably comprises polyethyleneimine and even more preferably it is an ethoxylated polyethyleneimine. Preferably the composition of the invention comprises from 0.1% to about 5%, preferably from about 0.2% to about 3% by weight of the composition of the polyalkyleneimine. Compositions comprising an alkoxylated polyalkyleneimine further contribute to drying and shine, in particular when the aloxylated polyalkyleneimine comprising an alkoxylated polyalkyleneimine said alkoxylated polyalkyleneimine comprising a polyalkyleneimine backbone, alkoxy chains and quaternization groups wherein the alkoxylated polyalkyleneimine has a degree of quaternization of from 40% to 98% and wherein:
(i) the polyalkyleneimine backbone represents from 1% to 40% by weight of the alkoxylated polyalkyleneimine;
(ii) the alkoxy chains represent from 60% to 99% by weight of the alkoxylated polyalkyleneimine.

The alkoxylation of the polyalkyleneimine backbone comprises one or two alkoxylation modifications in a nitrogen atom, depending on whether the modification occurs at an internal nitrogen atom or at a terminal nitrogen atom in the polyalkyleneimine backbone, the alkoxylation modification involves the replacement of a hydrogen atom in a polyalkyleneimine by a monoalkoxylene or a polyalkoxylene chain preferably having an average of from about 1 to about 50 alkoxy units, wherein the terminal alkoxy unit of the polyalkoxylene chain is capped with hydrogen, C1-C4 alkyl or mixtures thereof. In addition, each nitrogen atom in the alkoxylated polyalkyleneimine may carry saturated or unsaturated, linear or branched alkyl, alkylaryl or aryl substituents, or combinations thereof, preferably benzyl substituents and/or C1-C12, preferably C1-C4 alkyl, aryl or alkylaryl substituents, resulting in neutral or cationic charge on each nitrogen atom depending on its total number of substituents. These modifications may result in permanent quaternization of polyalkyleneimine backbone nitrogen atoms. The degree of permanent quaternization is at least 5%, preferably at least 20%, more preferably from at least from 40% to 100% of the polyalkyleneimine backbone nitrogen atoms.

Preferably, all the nitrogen atoms would comprise alkoxylation modification(s) although it might be possible to have polyalkyleneimines wherein only part of the nitrogen atoms have been alkoxylated.

Examples of possible modifications are herein shown, the modifications correspond to terminal nitrogen atoms in the polyethyleneimine backbone where R represents an ethylene spacer and E represents a C1-C12 alkyl unit and X− represents a suitable water soluble counterion, such as chlorine, bromine or iodine, sulphate (i.e. —O—SO3H or —O—SO3-), alkylsulfonate such as methylsulfonate, arylsulfonate such as tolylsulfonate, and alkyl sulphate, such as methosulphate (i.e. —O—SO2—OMe)).

Examples of possible modifications are shown, the modifications correspond to internal nitrogen atoms in the polyethyleneimine backbone where R represents an ethylene spacer and E represents a C1-C12 alkyl unit and X− represents a suitable water soluble counterion.

Also, for example, but not limited to, below is shown possible modifications to internal nitrogen atoms in the polyethyleneimine backbone where R represents an ethylene spacer and E represents a C1-C12 alkyl unit and X− represents a suitable water soluble counterion.

The alkoxylation modification of the polyalkyleneimine backbone may comprise the replacement of a hydrogen atom by a polyalkoxylene chain having an average of about 1 to about 50 alkoxy units, preferably from about 2 to about 40 alkoxy units, more preferably from about 3 to about 30 units and especially from about 3 to about 20 alkoxy units. The alkoxy units are preferably selected from ethoxy (EO), 1,2-propoxy (1,2-PO), butoxy (BO), and combinations thereof. Preferably, the polyalkoxylene chain is selected from ethoxy units and a combination of ethoxy and propoxy units. More preferably, the polyalkoxylene chain comprises ethoxy units in an average degree of from about 1 to about 50, more preferably from about 2 to about 40 and especially from about 3 to 20. Polyalkyleneimines comprising this degree of ethoxy units have been found to provide best performance in terms of removal of bleachable stains, in particular tea and coffee stains. Also preferred in terms of bleachable stain removal are polyalkoxylene chains comprising a mixture of ethoxy and propoxy chains, preferably the polyalkoxylene chain comprises ethoxy units in an average of from about 1 to about 30 and more preferably propoxy units in an average degree of from about 0 to about 10, more preferably from about 2 to about 20 ethoxy units and from about 1 to about 10 propoxy units.

Crystal growth inhibitors are materials that can bind to calcium carbonate crystals and prevent further growth of species such as aragonite and calcite.

Especially preferred crystal growth inhibitor for use herein is HEDP (1-hydroxyethylidene 1,1-diphosphonic acid).

Metal care agents may prevent or reduce the tarnishing, corrosion or oxidation of metals, including aluminium, stainless steel and non-ferrous metals, such as silver and copper.

Glass care agents protect the appearance of glass items during the dishwashing process. Preferably the glass care agent is a zinc containing material, specially hydrozincite.

The automatic dishwashing composition of the invention preferably has a pH as measured in 1% weight/volume aqueous solution in distilled water at 20° C. of from about 9 to about 12, more preferably from about 10 to less than about 11.5 and especially from about 10.5 to about 11.5.

The automatic dishwashing composition of the invention preferably has a reserve alkalinity of from about 10 to about 20, more preferably from about 12 to about 18 at a pH of 9.5 as measured in NaOH with 100 grams of product at 20° C.

### EXAMPLES

The following is an illustrative example of a pouch in accordance with the present invention.

A superimposed ellipsoid pouch made of polyvinyl alcohol film that encloses an automatic dishwashing detergent composition. The pouch having a major axis of 50 mm, a minor axis of 35 mm, and a height of 15 mm, the total internal compartment volume being 24 ml. The solid component of the composition being enclosed in a first section. The first section having a major axis of 50 mm, a minor axis of 35 mm, and a height of 10 mm, and a total internal volume of 20 ml. The liquid component of the composition being enclosed in a second section that has 4 separate compartments. The height of the second section being 5 mm, and the total internal volume of the second section being 4 ml.

The composition has the following composition.

| | |
|---|---|
| Ingredient | grams active |

Solid component

| | |
|---|---|
| trisodium salt of methylgylcine | 4 |
| diacetic acid | |
| sodium citrate | 1.5 |
| sodium carbonate | 2.5 |
| sodium silicate | 0.6 |
| sodium percarbonate | 3 |
| 1-hydroxyethane 1,1-diphosphonic | 0.7 |
| acid | |
| sulphonated, carboxylated polymer | 0.8 |
| tetraacetylethylenediamine | 0.5 |
| metal bleach catalyst | 0.008 |
| protease | 0.09 |
| amylase | 0.01 |
| processing aids (including fillers and | 6.5 |
| perfume) | |
| Total amount of solid component | 20.208 |

Liquid component (distributed within 4 separate compartments)

| | |
|---|---|
| alcohol alkoxylate | 1.6 |
| polyalkylene oxide block copolymer | 1.6 |
| processing aids (including water, dyes | 1.2 |
| and solvents) | |
| Total amount of liquid component | 4.4 |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

What is claimed is:

1. A superposed multi-sectioned water-soluble unit dose automatic dishwashing detergent pouch, the pouch comprising:
a first section that is superposed onto a second section, wherein the first section comprises one or more internal compartments, and the second section comprises one or more internal compartments,
wherein the pouch contains an automatic dishwashing detergent composition, and the automatic dishwashing detergent comprises a first component and a second component,
wherein the first section of the pouch contains the first component, and the second section of the pouch contains the second component,
wherein the pouch has an ellipsoid shape having the following dimensions:
(i) a major axis in the range of from 42 mm to 90 mm;
(ii) a minor axis in the range of from 30 mm to 54 mm;
(iii) a height in the range of from 14 mm to 41 mm; and
(iv) a total internal compartment volume in a range of from 18 ml to 199 ml,
wherein the first section has the following dimensions:
(i) a first section major axis in the range of from 42 mm to 90 mm;
(ii) a first section minor axis in the range of from 30 mm to 54 mm;
(iii) a first section height in the range of from 10 mm to 39 mm; and
(iv) a first section total internal compartment volume in a range of from 12.6 ml to 189.54 ml, and
wherein the second section has the following dimensions:
(i) a second section height of from 2.0 mm to 31 mm; and
(ii) a second section total internal compartment volume of at least 3.0 ml.

2. The pouch according to claim 1, wherein the automatic dishwashing detergent comprises from 2600 mg to 6000 mg surfactant.

3. The pouch according to claim 1, wherein the automatic dishwashing detergent composition comprises a surfactant selected from:
(i) R—O-EOₓ, wherein R is a C₆-C₁₈ alkyl, and x is from 1 to 30; or
(ii) R—O-EOₓPO_{y}, wherein R is a C₆-C₁₈ alkyl, x is from 1 to 20, and y is from 1 to 20; or
(iii) R—O—PO_{y}EOₓ, wherein R is a C₆-C₁₈ alkyl, x is from 1 to 20, and y is from 1 to 20; or
(iv) R—O-EOₓPO_{y}EOₓ, wherein R is a C₆-C₁₈ alkyl, each x is independently from 1 to 20, and y is from 1 to 20; or
(v) R—O—PO_{y}EOₓPO_{y}, wherein R is a C₆-C₁₈ alkyl, x is from 1 to 20, and each y is independently from 1 to 20; or
(vi) HO-EOₓPO_{y}EOₓ—H, wherein, each x is independently from 1 to 50, and y is from 1 to 20; or
(vii) HO—PO_{y}EOₓPO_{y}—H, wherein x is from 1 to 50, and each y is independently from 1 to 50; or
(viii) any combination thereof.

4. The pouch according to claim 1, wherein the second section comprises at least three internal compartments, wherein each of the at least three internal compartments contain a portion of the second component, and wherein each of the three internal compartments contains:
(i) a surfactant having the structure R—O-EOₓ, wherein R is a C₆-C₁₈ alkyl, and x is from 1 to 30; and
(ii) a surfactant having the structure HO-EOₓPO_{y}EOₓ—H, wherein, each x is independently from 1 to 50, and y is from 1 to 20.

5. The pouch according to claim 4, wherein the second section comprises a fourth internal compartment, wherein the fourth internal compartment of the second section contains a portion of the second component, and wherein the fourth internal compartment contains:
(i) a surfactant having the structure R—O-EOₓ, wherein R is a C₆-C₁₈ alkyl, and x is from 1 to 30;
(ii) a surfactant having the structure HO-EOₓPO_{y}EOₓ—H, wherein, each x is independently from 1 to 50, and y is from 1 to 20; and
(iii) a surfactant having the structure R—O—PO_{y}EOₓPO_{y}, wherein R is a C₆-C₁₅ alkyl, x is from 1 to 20, and each y is independently from 1 to 20.

6. The pouch according to claim 5, wherein the second section comprises a fifth internal compartment, wherein the fifth internal compartment of the second section contains a portion of the second component, and wherein the fifth internal compartment contains:
(i) a surfactant having the structure R—O-EOₓ, wherein R is a C₆-C₁₈ alkyl, and x is from 1 to 30;
(ii) a surfactant having the structure HO-EOₓPO_{y}EOₓ—H, wherein, each x is independently from 1 to 50, and y is from 1 to 20; and
(iii) a surfactant having the structure R—O—PO_{y}EOₓPO_{y}, wherein R is a C₆-C₁₈ alkyl, x is from 1 to 20, and each y is independently from 1 to 20.

7. The pouch according to claim 1, wherein the automatic dishwashing detergent comprises, on an active enzyme basis, from 0.5 mg to 5.0 mg of amylase.

8. The pouch according to claim 1, wherein the automatic dishwashing detergent comprises, on an active enzyme basis, from 10 mg to 50 mg of protease.

9. The pouch according to claim 1, wherein the automatic dishwashing detergent comprises, on an active enzyme basis:
(i) from 0.5 mg to 5.0 mg of amylase; and
(ii) from 10 mg to 50 mg of protease.

10. The pouch according to claim 1, wherein the automatic dishwashing detergent composition comprises a protease and at least two additional enzymes selected from lipase, phospholipase, bleaching enzyme, cellulase, glucanase, hemicellulose, mannanase, xylanase, and/or glycosyl hydrolase.

11. The pouch according to claim 1, wherein the automatic dishwashing detergent comprises:
(i) from 500 mg to 2000 mg methylglycine-N,N-diacetic acid and/or a salt thereof; and
(ii) from greater than 2000 mg to 12000 mg citric acid and/or a salt thereof.

12. The pouch according to claim 11, wherein a weight ratio of methylglycine-N,N-diacetic acid and/or a salt thereof to citric acid and/or a salt thereof is in a range of from 0.08:1 to 0.90:1.

13. The pouch according to claim 1, wherein the automatic dishwashing detergent composition is free of benzotriazole and tolyltriazole.

14. The pouch according to claim 1, wherein the automatic dishwashing detergent composition comprises less than 3000 mg of percarbonate bleach.

15. The pouch according to claim 1, wherein the first component is in solid particulate form, the second component is in liquid form, and a weight ratio of the first component to the second component is in a range of from 2.0:1 to 5.0:1.
